(19) United States
(12) Patent Application Publication
(10) Pub. No.: US 2025/0083158 A1
(43) Pub. Date: Mar. 13, 2025

(54) HANDHELD LIQUID SPRAY GUN

(71) Applicant: Spraying Systems Co., Wheaton, IL (US)

(72) Inventors: Jacob L. Snyder, Chicago, IL (US); Kyle P. Smolinski, Wheaton, IL (US); Evan A. Salmon, Wheaton, IL (US)

(21) Appl. No.: 18/884,867

(22) Filed: Sep. 13, 2024

Related U.S. Application Data
(60) Provisional application No. 63/538,206, filed on Sep. 13, 2023.

(51) Int. Cl. B05B 1/30; B05B 1/34; B05B 9/01

(52) U.S. Cl. CPC B05B 1/3046; B05B 1/3402; B05B 9/01

(57) ABSTRACT

A handheld spray gun effective for directing a high pressure turbulence free discharge spray. The spray gun comprises a barrel with an angularly disposed handle, a barrel liquid supply conduit for directing liquid from a liquid supply to a discharge orifice of the barrel, and a valve stem disposed within the barrel liquid supply conduit for relative movement between discharge orifice opening and closing positions. A magnet assembly comprising a pair of magnets disposed outside the liquid supply conduit is effective for biasing the valve stem to a discharge orifice closing position responsive to repelling magnetic force of the magnets, and a trigger actuatable for moving the valve stem against the repelling magnetic force of the magnet assembly for opening the discharge orifice with the opposing magnetic force of the magnets forcing the valve stem to a discharge orifice closing position upon release of the trigger.

### CROSS-REFERENCE TO RELATED APPLICATION

This patent application claims the benefit of U.S. Provisional Patent Application No. 63/538,206, filed Sep. 13, 2023, which is incorporated by reference.

### FIELD OF THE INVENTION

The present invention relates generally to handheld liquid spray guns, and more particularly, to handheld spray guns adapted for directing high pressure cleaning fluids.

### BACKGROUND OF THE INVENTION

Many industrial production applications rely on extensive cleaning, both during production runs and during dedicated cleaning shifts, to ensure the production area is both a clean and safe environment for workers and products alike. In some cases, such as food production, this is particularly important. Production lines must be thoroughly cleaned and sanitized between production runs to ensure food products are free of contamination resulting from previous production processes.

One of the most common and conveniently used methods of cleaning such production areas, regardless of industry, is the general-purpose handheld washdown guns. These handheld devices are easily held and manipulated and use a trigger mechanism to open a valve, releasing high pressure water and cleaning solutions to be sprayed onto surfaces contaminated with product, excess ingredients, and general grime. Such guns in the past have largely relied on an internal spring-based mechanism to control the opening and closing of the valve regulating the distribution of fluid. The internal control spring commonly is disposed about the liquid control valve in the liquid flow path and can cause turbulence in the dispensed liquid that can detract from the cleaning effectiveness of the discharging spray. Turbulence from the direction of high pressure fluid through the gun further can detract from steady and reliable trigger control of the gun.

### OBJECTS AND SUMMARY OF THE INVENTION

It is an object of the invention to provide a handheld spray gun with a valve biasing arrangement that facilitates turbulence free transmission of liquid flow through the spray gun when spraying high pressure liquids.

Another object is to provide a handheld spray gun as characterized above that does not utilize a valve biasing spring or the like in the liquid flow path that can impede and impart turbulence in high pressure liquids dispensed by the spray gun.

Still another object is to provide a handheld spray gun of the forgoing type that has a non-mechanical valve biasing arrangement that provides a unique trigger pull feel and enables easier operation of the gun when spraying high pressure liquids.

Other objects and advantages of the invention will become apparent upon reading the following detailed description and upon reference to the drawings. The identified objects are not intended to limit the present invention.

### BRIEF DESCRIPTION OF THE SEVERAL VIEWS OF THE DRAWING(S)

FIG. 1 is a cut away perspective of a handheld spray gun in accordance with the invention with the trigger in an unactuated valve closing position;

FIG. 2 is a cut away perspective, similar to FIG. 1, but with the trigger in actuated valve opening position;

FIG. 3 is an enlarged fragmentary vertical section of the illustrated spray gun, with the trigger in an unactuated valve closing position;

FIG. 4 is an enlarged fragmentary vertical section of the illustrated spray gun similar to FIG. 3 but with the trigger in an actuated valve open position;

FIG. 5 is an enlarged fragmentary vertical section of the barrel liquid supply conduit of the illustrated spray gun taken into plane of line 5-5 in FIG. 4;

FIG. 6 is a horizontal section taken into plane of line 6-6 in FIG. 3;

FIG. 7 is a horizontal section taken into plane of line 7-7 in FIG. 4;

FIG. 8 is an enlarged horizontal section of the magnetic valve biasing assembly of the illustrated embodiment with the magnets in a separated valve closing position; and

FIG. 9 is an enlarged horizontal section, similar to FIG. 8, with the magnets more closely drawn together to a valve opening position.

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DETAILED DESCRIPTION OF THE INVENTION

Referring now more particularly to the drawings, there shown an illustrated spray gun 10 in accordance with the invention. The spray gun 10 has an outer casing or housing 11 which includes a horizontally disposed barrel 12 and a handle 14 supported in depending relation to the barrel 12 with an actuating trigger 15 mounted on the underside of the barrel 12 forwardly of the handle 14. The spray gun 10 in this case has a trigger guard 16 extending from an underside of the barrel 12 outwardly around the trigger 15 coupled to a lower end of the handle 14.

The spray gun 10 has a liquid inlet conduit 18 disposed within the handle 14 having a lower end for coupling to a liquid supply, such as a supply of cleaning fluid or other liquid pressurized up to 350 psi. to 1000 psi. The liquid inlet conduit 18 communicates with a transversely directed, in this case horizontal, barrel liquid supply conduit 20 housed within the barrel 12 that in turn communicates with an orifice member 21 which in this case defines a central discharge orifice 22 having an outwardly flared terminal end 24. The orifice member 21 has an upstream externally threaded upstream end 25 secured within downstream end of the barrel liquid supply conduit 20 and a sealing member 26, such as an O-ring of a known type, mounted in an upstream end of the discharge orifice 22 that forms a valve seat.

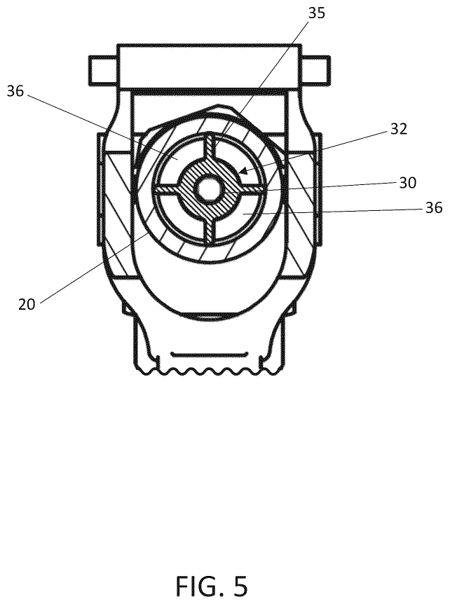

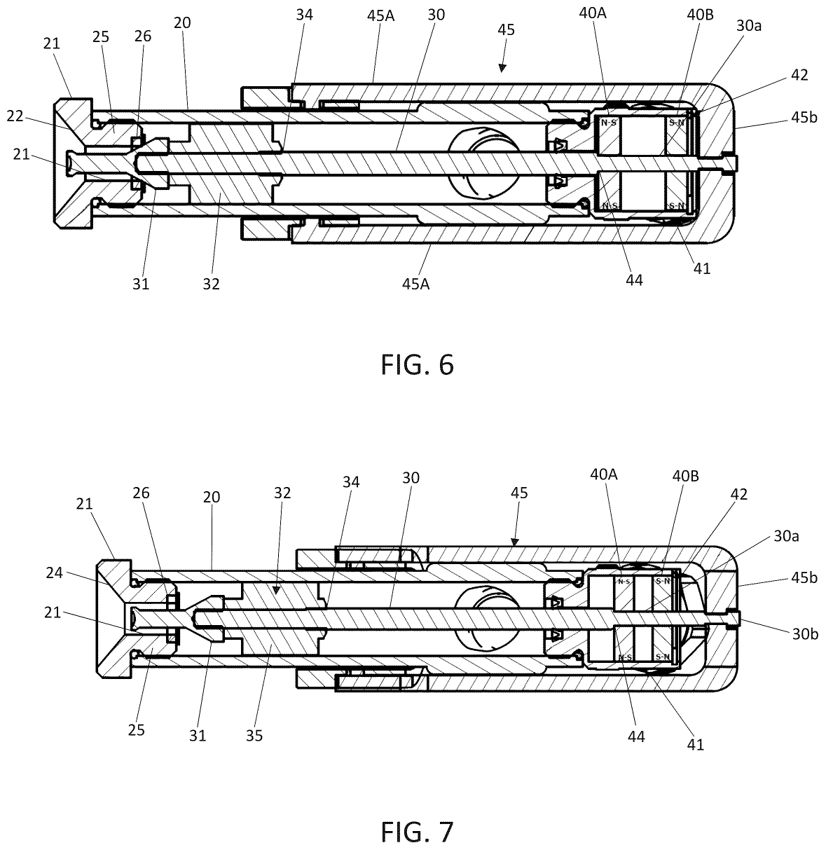

An elongated valve stem 30 having a valve pintle 31 at a downstream end is centrally disposed within the barrel liquid supply conduit 20 for relative movement between valve opening and closed positions, as will become apparent. A flow straightener 32 mounted on the valve stem 30 serves to keep the valve stem 30 centered in the barrel liquid flow conduit 20 and ensure a uniform flow pattern for direction through the discharge orifice 22. The liquid flow straightener 32 in this case is positioned on the valve stem 30 between the rear of the pintle 31 and a step 34 on the valve stem 30 (FIGS. 6 and 7) for movement with the valve stem 30. Fins 35 of the flow straightener 32 (FIG. 5) which define a plurality of circumferentially spaced liquid flow passages 36 rest against the inner diameter of the barrel liquid supply conduit 20 keeping the valve stem 30 and valve pintle 31 centered within the barrel liquid supply conduit 20.

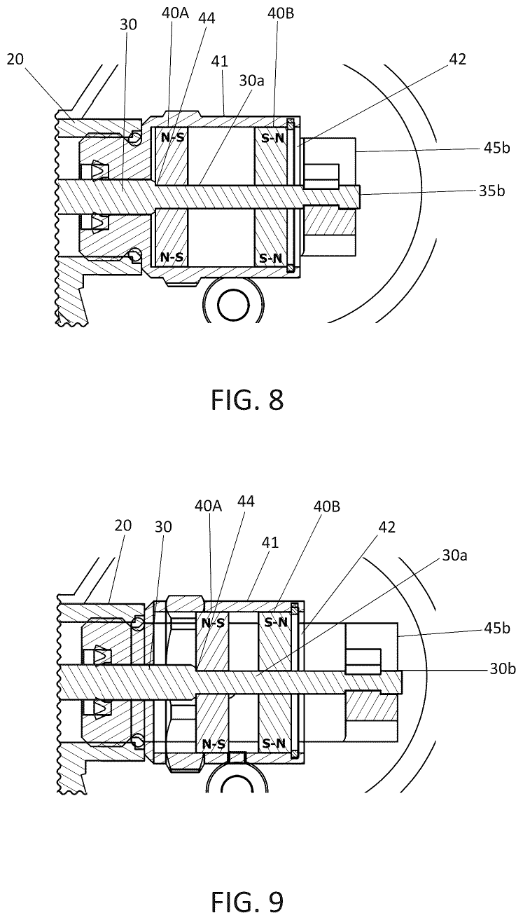

In carrying out an important feature of the present embodiment, the spray gun 10 has a non-mechanical valve biasing arrangement disposed outside the liquid flow path so as to not to interfere with or create turbulence in liquid passing through the spray gun and which facilitates easier trigger control in operating the spray gun when dispensing high pressure liquids. More particularly, a magnet assembly is mounted outside an upstream end of the barrel liquid supply conduit 20 which includes a pair of magnets 40A, 40B disposed with common polarities in facing relation to each other so as to create an opposing magnetic force between the magnets. The magnets 40A, 40B in this case are disposed within a cylindrical housing 41 (FIGS. 8 and 9) mounted adjacent an upstream end of barrel liquid supply conduit 20. The magnet housing 41 has a downstream externally threaded cylindrical hub 42 secured within an upstream end of the barrel liquid supply conduit 20. An outer or upstream end of the magnet housing 41 is closed by a removable end cap ring 42, such as a C-type retaining ring of a known type, with a rear extension 30a of the valve stem 30 extending centrally through the magnet housing 41 and outwardly a central opening of the end cap ring 42.

The magnets 40A, 40B in this case are ring magnets mounted on the rear extension of the valve stem 30 with the magnet 40A being forwardly mounted and the magnet 40B being rearely mounted. The rear magnet 40B is maintained against the housing end cap ring 42 by the opposing magnetic forces of the magnets 40A, 40B.

The forward magnet 40A in this instance is forced against a step 44 (FIGS. 6 and 7) of the valve stem 30 at the forward end of the magnet housing 41 by the magnetic opposition forces between the magnets 40A, 40B. Being pressed against the step 44, the magnetic oppositions forces between the magnets 40A, 40B push the forward magnet 40A, as well as a valve stem 30, liquid straightener 32, and valve pintle 31 forwardly such that the valve pintle 31 closes the valve discharge orifice 21.

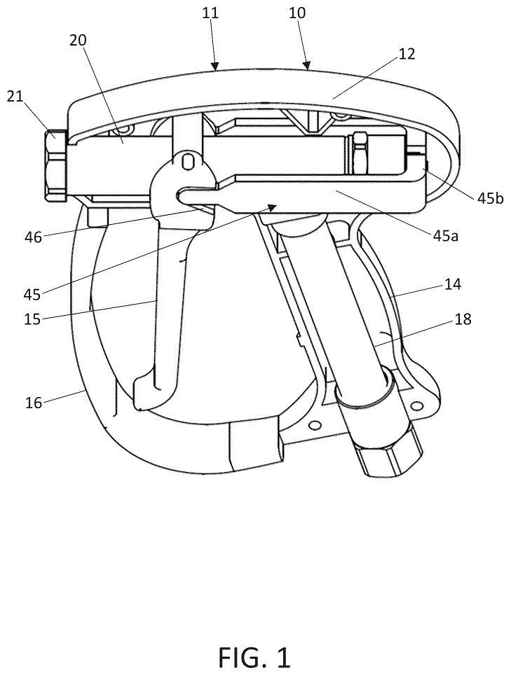

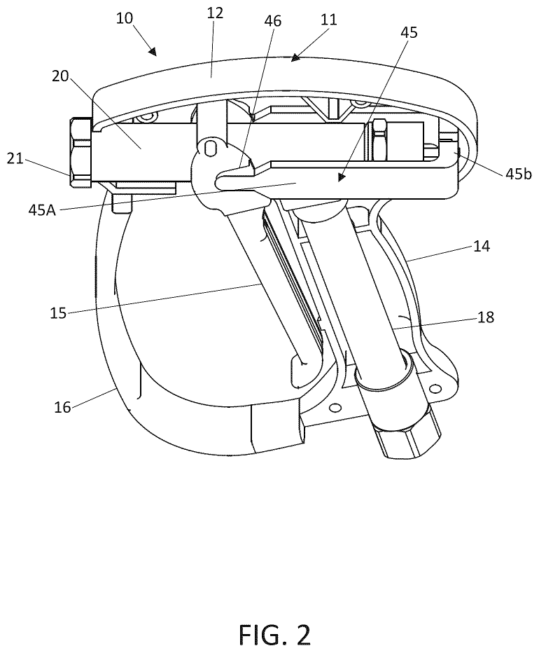

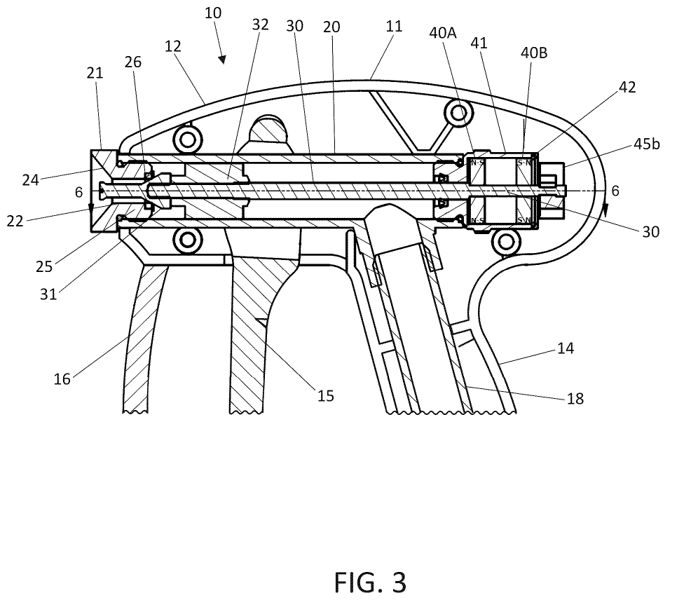

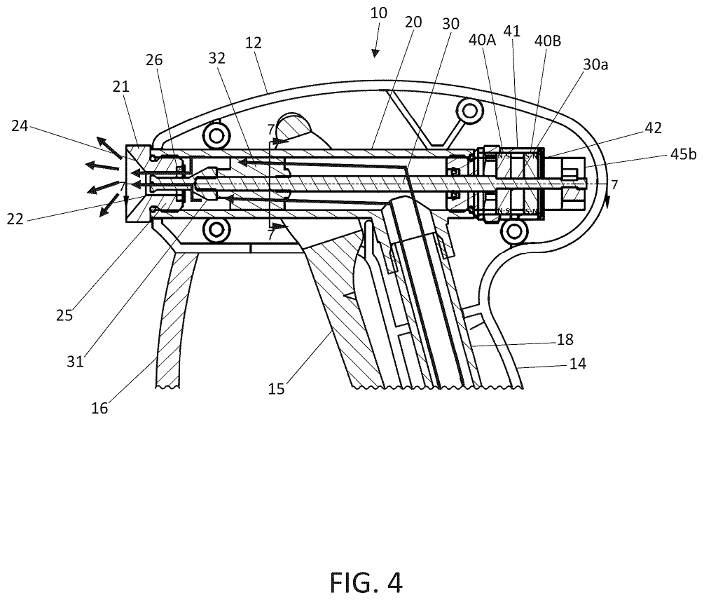

For overcoming the magnetic force that urges the stem 30 forwardly to close the discharge orifice 21, a trigger actuated linkage is provided that includes U-shaped linkage 45 for transferring angular motion of the trigger 15 into horizontal movement of the U-shaped linkage 45 for retracting the valve stem 30 to a valve opening position. The U-shaped linkage 45 in this case includes a pair of legs 45a extending along opposite sides of the barrel liquid supply conduit 20 and a transverse connecting end 45b through which the terminal end of the valve stem 30 extends. The terminal end of the valve stem 30 has an enlarged diameter head 30b disposed within an outwardly opened counter bore of the connecting end 45b of the linkage. Upstream ends of the linkage legs 45a are disposed in eccentric slot 46 of the trigger 18 (FIGS. 1 and 2) such that upon pivotal movement of the trigger 18 from a valve closing position, as indicated in FIGS. 1, 3, and 6, to a valve opening position, as depicted in FIGS. 2, 4, and 7, the linkage 45 is moved rearerly drawing the valve stem 30 rearwordly opening the valve discharge orifice 21 while simultaneously moving the forward magnet 40A into closer relation to the rear magnet 40B.

As the linkage 45 and valve stem 30 are drawn rearely the discharge orifice 21 is opened allowing liquid to pass through the barrel liquid supply conduit 20 for discharge from the spray gun. While this is occurring, the forward magnet 40A is moved rearerly inside the magnet housing 41 by the step 44 on the valve stem 30. It is drawn closer to the rear-most magnet 40B which is held in place in the magnet housing 41 by the end cap ring 42. As the distance between the magnets 40A, 40B decreases, the magnetic opposition force between them increases, until it reaches a maximum level when the valve pintle 31 is completely retracted from the valve discharge orifice 24. At this point, the trigger 15 is holding the valve stem 30 in such position, as it provides a linear force equivalent to that of the magnetic opposition force generated by the magnets 40A, 40B.

When the trigger 15 is released, the linear force equaling the magnetic opposition force generated by the magnets 40A, 40B is removed. Now, the increased magnetic opposition forces between the magnets 40A, 40B causes them to be forced apart. The rear-most magnet 40B is held in position by the rear plate and cannot move further rearward. Thus, the forward magnet 40A is forced to move forward inside of the magnet housing 7. As the magnetic opposition force urges the forward magnet 40A forwardly, it pushes the valve stem 30 forward with it due to the engagement of the magnet 40A against the step 44 in the valve stem 30. As the magnet 40A pushes the valve stem 30 forward, so too are the flow straightener 32 and valve pintle 31 pushed forwardly as they are connected to the valve stem 30. The forward magnet 40A, the valve stem 30, the flow straightener 32, and the pintle 31 are pushed forward by the magnetic opposition forces between the magnets 40A, 40B until the valve pintle 31 engages the seal 26 closing the discharge orifice 21. With the magnets 40A, 40B at their maximum separation and the magnetic opposition forces between them are at their lowest, but sufficient for maintaining the valve pintle in a closed position.

From the foregoing, it can be seen that a handheld spray gun is provided with a valve biasing mechanism that facilitates turbulent free transmission of high pressure liquids through the spray gun. The magnetic biasing mechanism further facilitates easy trigger control when spraying such high pressure fluids.

What is claimed:

1. A spray gun comprising:
a housing comprising a barrel and a handle disposed in angular relation to the barrel;
an orifice member defining a discharge orifice adjacent a downstream end of said barrel;
said barrel having a liquid supply conduit for directing liquid from a liquid supply to said discharge orifice;
a valve stem disposed within said barrel liquid supply conduit for relative movement between discharge orifice opening and closing positions;
a magnet assembly for biasing said valve stem to said discharge orifice closing position responsive to repelling magnetic force of said magnet assembly;
a trigger actuatable for moving said valve stem against the repelling magnetic force of said magnet assembly for enabling the flow of liquid through said liquid supply conduit for discharge from said discharge orifice; and
said repelling magnetic force of said magnet assembly being effective for urging said valve stem to said discharge orifice closing position upon release of said trigger.

2. The spray gun of claim 1 including trigger actuatable for transferring angular motion of the trigger into translational movement of the valve stem for retracting the valve stem against the magnetic force of said magnet assembly.

3. The spray gun of claim 1 in which said magnet assembly includes a pair of magnets with common polarities of the magnets disposed in opposed relation to each other for creating a repelling magnetic force between the magnets.

4. The spray gun of claim 1 in which the magnet assembly is disposed outside of said liquid supply conduit.

5. The spray gun of claim 4 in which said magnet assembly is mounted outside an upstream end of said barrel liquid supply conduit.

6. The spray gun of claim 1 in which said handle includes a liquid inlet conduit communicating between an inlet of said barrel liquid supply conduit and said liquid supply.

7. The spray gun of claim 3 in which said pair of magnets are ring magnets mounted on a rear extension of said valve stem; one of said ring magnets being rearwardly mounted against a stop surface fixed to said barrel liquid supply conduit and the other of said magnets is forwardly mounted against a stop surface on said valve stem; and the repelling magnetic force of said magnets forces said forwardly mounted magnet against said stop surface on said valve stem and said rearward magnet against the stop fixed to the liquid supply conduit.

8. The spray gun of claim 7 in which said magnets are disposed within a cylindrical housing affixed to an upstream end of said barrel liquid supply conduit; and said stop surface of said rearwardly mounted magnet being an upstream end cap of said housing.

9. The spray gun of claim 6 in which said barrel includes an outer barrel housing through which said barrel liquid supply conduit extends, and said handle includes an outer housing through which said handle liquid inlet conduit extends.

10. The spray gun of claim 1 including a flow straightener mounted within said barrel liquid supply conduit for maintaining the valve stem centered within the barrel liquid supply conduit and maintaining the uniform flow of liquid through said liquid supply conduit.

11. The spray gun of claim 10 in which said flow straightener has a plurality of radial fins that define a plurality of circumferentially spaced liquid flow passages.

12. A spray gun comprising:
a housing comprising a barrel and a handle disposed in angular relation to the barrel;
an orifice member defining a discharge orifice adjacent a downstream end of said barrel;
said barrel having a liquid supply conduit for directing liquid from a liquid supply to said discharge orifice;
a valve stem disposed within said barrel liquid supply conduit for relative movement between discharge orifice opening and closing positions;
a magnet assembly mounted on an upstream end of said barrel liquid supply conduit including a pair of magnets with common polarities of the magnets disposed in opposed relation to each other for creating a repelling magnetic force between the magnets for biasing said valve stem to said discharge orifice closing position;
a trigger pivotally mounted on said housing;
actuating linkage for transferring pivotal motion of the trigger into translational movement of the valve stem for retracting the valve stem against the repelling magnetic force of the magnets to a position opening said discharge orifice and enabling the flow of liquid through said liquid supply conduit for discharge from said discharge orifice; and
said repelling magnetic force of said magnets being effective for urging said valve stem to said discharge orifice closing position upon release of said trigger.

13. The spray gun of claim 12 in which said handle includes a liquid inlet conduit communicating between an inlet of said barrel liquid supply conduit and said liquid supply.

14. The spray gun of claim 12 in which said pair of magnets are ring magnets mounted on a rear extension of said valve stem; one of said ring magnets being rearwardly mounted against a stop surface fixed to said barrel liquid supply conduit and the other of said magnets is forwardly mounted against a stop surface on said valve stem; and the repelling magnetic forces of said magnets force said forwardly mounted magnet against said stop surface on said valve stem and said rearward magnet against the stop fixed to the liquid supply conduit.

15. The spray gun of claim 14 in which said magnets are disposed within a cylindrical housing affixed to an upstream end of said barrel liquid supply conduit; and said stop surface of said rearwardly mounted magnet being an upstream end cap of said housing.

16. The spray gun of claim 12 in which said barrel includes an outer barrel housing through which said liquid supply conduit extends, and said handle includes an outer housing through which said handle liquid inlet conduit extends.

17. The spray gun of claim 12 including a flow straightener having a plurality of radial vanes mounted within said barrel liquid supply conduit for maintaining the valve stem centered within the barrel liquid supply conduit and maintaining the uniform flow of liquid through said liquid supply conduit.
